(19) United States
(12) Patent Application Publication
(10) Pub. No.: US 2023/0196873 A1
(43) Pub. Date: Jun. 22, 2023

(54) Dealing Method, Game Method, Device, and Storage Medium

(71) Applicant: HANGZHOU FUZAMEI TECHNOLOGY CO., LTD., HangZhou, Zhejiang (CN)

(72) Inventors: Zhiwen WANG, Suzhou (CN); Sijin WU, Suzhou (CN)

(21) Appl. No.: 17/620,882

(22) PCT Filed: Apr. 29, 2020
(86) PCT No.: PCT/CN2020/087829

§ 371 Date: Dec. 20, 2021

(30) Foreign Application Priority Data
May 22, 2019 (CN) 201910430885.1

(51) Int. Cl. G07F 17/32; H04L 9/00; H04L 9/14; H04L 9/32

(52) U.S. Cl. CPC G07F 17/3234; G07F 17/3241; G07F 17/3293; H04L 9/50; H04L 9/14; H04L 9/3247

(57) ABSTRACT

A dealing method, a game method, a device, and a storage medium. The dealing method comprises: generating a first key by means of an algorithm supporting out-of-order decryption, and recording a hash value of the first key onto a blockchain (S11); generating a plurality of pieces of card surface information and corresponding scramble information, and respectively encrypting by means of the first key (S12); sending the encrypted card surface information to another user side for reshuffling cards in turn by other user sides (S13); receiving the encrypted card surface information broadcasted by the user side which finally shuffles, and determining the plurality of pieces of encrypted card surface information allocated to the current user (S14); generating a plurality of pieces of first decryption request information and sending same to another user side for decryption by the other user sides in turn, and then returning a plurality of first decryption results (S15); decrypting by means of the first key to obtain the card surface information allocated to the current user (S16); using the first key to decrypt a plurality of pieces of second decryption request information sent by other user sides so as to generate a second decrypted result, and sending same to the next user side (S17). The decentralized dealing is implemented.

### BACKGROUND OF THE PRESENT INVENTION

### Field of Invention

The present invention relates to the technical field of decentralized gaming, and in particular, to a dealing method, game method, device, and storage medium.

### Description of Related Arts

In current card games for either centralized game or decentralized game, it cannot implement decentralized dealing, instead, only centralized dealing can be utilized.

However, centralized dealing renders that the dealer know all the cards of the players, and once the dealer leaks the card information, or the dealer cheats, the fairness of the game will be affected.

### SUMMARY OF THE PRESENT INVENTION

In accordance with the defects or drawbacks of the conventional technologies, the present invention provides a decentralized dealing method, game method, device, and storage medium.

In a first aspect, the present invention provides a dealing method, comprising:

generating a first key by means of an algorithm supporting out-of-order decryption, and recording a hash value of the first key onto a blockchain, wherein all other user sides participating in the current round of game respectively generate key through the algorithm and record a hash value of the first key onto the blockchain;

generating a plurality of pieces of card surface information and corresponding scramble information, and respectively encrypting the card surface information and the corresponding scramble information by means of the first key so as to generate a plurality of pieces of encrypted card surface information that are encrypted for the first time;

sending the encrypted card surface information to another user side participating in the current round of game for reshuffling cards in turn by other user sides participating in the current round of game, until all user sides participating in the current round of game finish shuffling, wherein the shuffling comprises: encrypting the encrypted card surface information received respectively by means of the key generated according to the algorithm;

receiving the encrypted card surface information broadcasted after reshuffling by the user side which finally shuffles in the current round of game, and determining, according to a preconfigured drawing rule, the plurality of pieces of encrypted card surface information allocated to the current user;

generating a plurality of pieces of first decryption request information according to the allocated encrypted card surface information and sending same to another user sides participating in the current round of game for decryption by the other user sides participating in the current round of game in turn by means of the key generated based on the algorithm, and then returning a plurality of first decryption result by the user side of the user sides decrypting finally;

decrypting the first decryption result by means of the first key, and recognizing and filtering the scramble information to obtain the card surface information allocated to the current user; and

receiving a plurality of pieces of second decryption request information sent by other user sides participating in the current round of game, and decrypting same by means of the first key so as to generate a second decrypted result, and sending same to the next user side.

In a second aspect, the present invention provides a dealing method, comprising:

generating a second key by means of an algorithm supporting out-of-order decryption, and recording a hash value of the second key onto a blockchain, wherein all other user sides participating in the current round of game respectively generate key through the algorithm and record a hash value of the first key onto the blockchain;

receiving a plurality of pieces of encrypted card surface information transmitted by another user side participating in the current round of game, wherein the encrypted card surface information is an encrypted card surface information of first time encryption or an encrypted card surface information of second time encryption, wherein the encrypted card surface information of first time encryption is generated by a first user side starting the shuffling of the current round of game through generating a plurality of pieces of card surface information and corresponding scramble information and respectively encrypting the card surface information and the corresponding scramble information with a first key generated based on the algorithm and is sent to another user side participating in the current round of game, so as for the other user sides participating in the current round of game to successively reshuffling the cards, wherein the reshuffling comprising: encrypting all pieces of the encrypted card surface information received respectively with a key generated based on the algorithm so as to generate an encrypted card surface information of second time encryption;

encrypting the received encrypted card surface information based on the second key and determining whether all user sides participating in the current round of game have finished shuffling:

if no, sending all the encrypted card surface information generated based on the second key to the next user side who has not shuffled to reshuffle the cards, and waiting for the encrypted card surface information to be broadcasted after reshuffling by the user side which finally shuffles in the current round of game;

if yes, broadcasting all the encrypted card surface information generated based on the second key to the user sides participating in the current round of game;

determining the plurality of pieces of encrypted card surface information allocated to the current users according to the preconfigured drawing rule;

generating a plurality of pieces of third decryption request information according to the allocated encrypted card surface information and sending same to another user sides participating in the current round of game for decryption by the other user sides participating in the current round of game in turn by means of the key generated based on the algorithm, and then returning a plurality of third decryption results by the user side of the user sides decrypting finally;

decrypting the third decryption results by means of the second key, and recognizing and filtering the scramble information to obtain the card surface information allocated to the current user; and

receiving a plurality of pieces of fourth decryption request information sent by other user sides participating in the current round of game, and decrypting same by means of the second key so as to generate a fourth decrypted result, and sending same to the next user side.

In a third aspect, the present invention also provides a game method, comprising:

dealing, according to any of the above dealing methods;

sending dealing information in the game process to conducting dealing, wherein the dealing information comprises a first card surface information of the dealing, a first encrypted card surface information generated through successively shuffling the first card surface information by the user sides participating in the current round of game, and the signature information of the current users; and

after the current round of game is finished, publishing the keys generated by the current user sides and packaging and recording the result information of the current round of game onto the blockchain, so as for the game contract deployed on the blockchain to settle the current round of game.

In a fourth aspect, the present invention also provides a device, which includes one or more processors and a storage, wherein the storage includes commands executable by the one or more processors to allow the one or more processors to perform the methods provided in accordance with embodiments of the present invention.

In a fifth aspect, the present invention also provides a storage medium with computer program stored therein, so as for allowing a computer to perform a method provided in accordance with the embodiments of the present invention.

The dealing method, game method, device, and storage medium provided by various embodiments of the present invention achieve decentralized dealing allowing only each of the players know the cards s/he has in the game by means of having the user sides participating the game respectively generate keys based on an algorithm supporting out-of-order decryption, encryptedly record the keys onto the blockchain, respectively and successively utilize their keys to encryptedly shuffle the card surface information of the current round of game, successively decrypt the encrypted card surface information of each of the current user through other user sides after dealing, and eventually conduct the final decryption by each of the current user sides.

The dealing method, game method, device, and storage medium provided by some embodiments of the present invention further prevent cheating in the decryption processes through providing the signature of the current user in the decryption request sending to other user sides, so as to ensure that illegal decryption request can be checked and found after all the users have published their keys.

The game method, device, and storage medium provided by some embodiments of the present invention further prevent cheating in the card leading processes through attaching the signature of the current user along with the encrypted card surface information in card leading, so as to ensure illegal card leading can be checked and found after all the users have published their keys.

The game method, device, and storage medium provided by some embodiments of the present invention further enhance the system performance of decentralized games through performing local settling based on the local mutually broadcasted keys before submitting the game result to the blockchain, which reduces the computation load of the game contract on the blockchain.

### BRIEF DESCRIPTION OF THE DRAWINGS

Other features, objects, and advantages of the present application will become more obvious through referring to the detail descriptions of the embodiments that are illustrated in, but not limited by the following figures.

FIG. 1 is a flow diagram of a dealing method according to an embodiment of the present invention.

FIG. 2 is a flow diagram of another dealing method according to an embodiment of the present invention.

FIG. 3 is a flow diagram of a game method according to an embodiment of the present invention.

FIG. 4 is a flow diagram of a preferred embodiment of the method of FIG. 3.

FIG. 5 is a flow diagram of another preferred embodiment of the method of FIG. 3.

FIG. 6 is a composition diagram of a device according to an embodiment of the present invention.

### DETAILED DESCRIPTION OF THE PREFERRED EMBODIMENT

The present application is described in further detail below in connection with the accompanying drawings and embodiments. It is to be understood that the specific embodiments described herein are for illustrative purposes only and shall not limit the present invention. It is also to be noted that, for ease of description, only portions that are relevant to the present invention to be described are shown in the accompanying drawings.

It should be noted that, without conflict, features in the present application and features in the embodiments may be combined with each other. The present application will now be described in detail with reference to the accompanying drawings.

There are usually two types of dealing scenarios in card games:

Players show the cards they have received to all other players in, for example, all kinds of games of revealing cards.

Only the player knows the cards s/he has received, while the rest of the players do not know in, for example, all kinds of games of non-revealing cards, such as Landlords, Double Buckle.

The dealing methods provided by the present invention may be utilized in achieving decentralized dealing for the latter dealing scenario, while another application will provide methods for achieving decentralized dealing for the former dealing scenario.

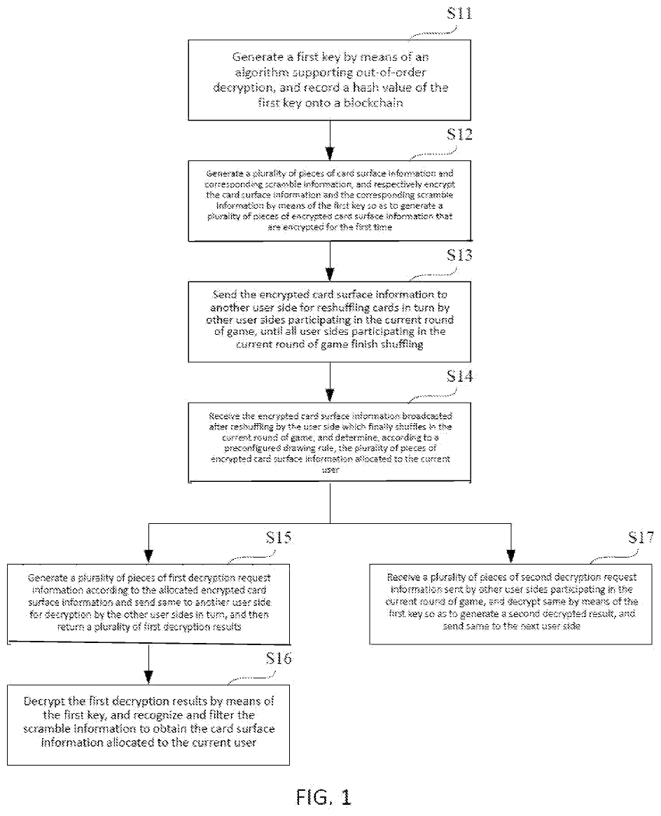

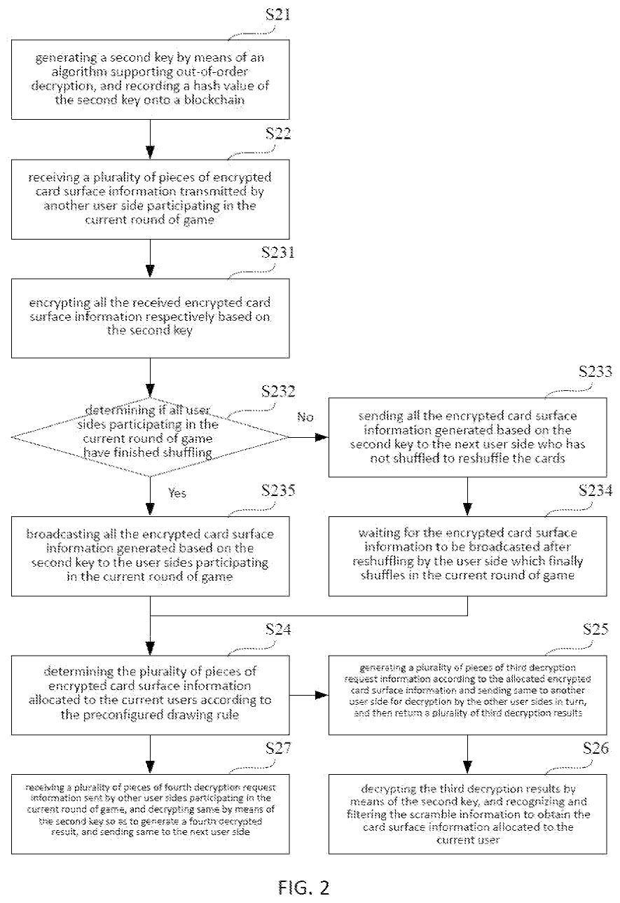

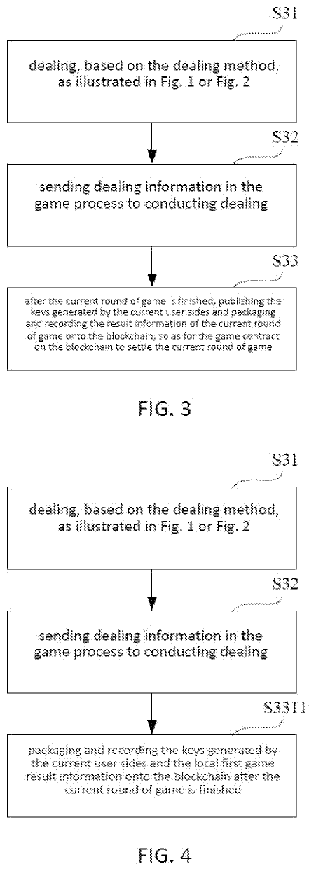

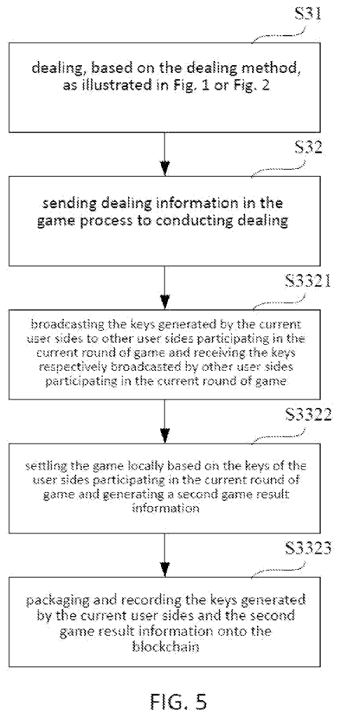

FIG. 1 is a flow diagram illustrating a dealing method according to an embodiment of the present invention. Referring to FIG. 1, according to the present embodiment, a dealing method of the present invention comprises:

S11: generating a first key by means of an algorithm supporting out-of-order decryption, and recording a hash value of the first key onto a blockchain, wherein all other user sides participating in the current round of game respectively generate key through the algorithm and record a hash value of the first key onto the blockchain;

S12: generating a plurality of pieces of card surface information and corresponding scramble information, and respectively encrypting the card surface information and the corresponding scramble information by means of the first key so as to generate a plurality of pieces of encrypted card surface information that are encrypted for the first time;

S13: sending the encrypted card surface information to another user side participating in the current round of game for reshuffling cards in turn by other user sides participating in the current round of game, until all user sides participating in the current round of game finish shuffling, wherein the shuffling comprises: encrypting the encrypted card surface information received respectively by means of the key generated according to the algorithm;

S14: receiving the encrypted card surface information broadcasted after reshuffling by the user side which finally shuffles in the current round of game, and determining, according to a preconfigured drawing rule, the plurality of pieces of encrypted card surface information allocated to the current user;

S15: generating a plurality of pieces of first decryption request information according to the allocated encrypted card surface information and sending same to another user sides participating in the current round of game for decryption by the other user sides participating in the current round of game in turn by means of the key generated based on the algorithm, and then returning a plurality of first decryption result by the user side of the user sides decrypting finally;

S16: decrypting the first decryption results by means of the first key, and recognizing and filtering the scramble information to obtain the card surface information allocated to the current user; and

S17: receiving a plurality of pieces of second decryption request information sent by other user sides participating in the current round of game, and decrypting same by means of the first key so as to generate a second decrypted result, and sending same to the next user side.

FIG. 2 is a flow diagram illustrating another dealing method according to an embodiment of the present invention. Referring to FIG. 2, according to the present embodiment, a dealing method also provided by the present invention comprises:

S21: generating a second key by means of an algorithm supporting out-of-order decryption, and recording a hash value of the second key onto a blockchain, wherein all other user sides participating in the current round of game respectively generate key through the algorithm and record a hash value of the first key onto the blockchain;

S22: receiving a plurality of pieces of encrypted card surface information transmitted by another user side participating in the current round of game, wherein the encrypted card surface information is an encrypted card surface information of first time encryption or an encrypted card surface information of second time encryption, wherein the encrypted card surface information of first time encryption is generated by a first user side starting the shuffling of the current round of game through generating a plurality of pieces of card surface information and corresponding scramble information and respectively encrypting the card surface information and the corresponding scramble information with a first key generated based on the algorithm and is sent to another user side participating in the current round of game, so as for the other user sides participating in the current round of game to successively reshuffling the cards, wherein the reshuffling comprising: encrypting all pieces of the encrypted card surface information received respectively with a key generated based on the algorithm so as to generate an encrypted card surface information of second time encryption;

S231: encrypting all the received encrypted card surface information respectively based on the second key;

S232: determining if all user sides participating in the current round of game have finished shuffling:

if no, executing the step S233: sending all the encrypted card surface information generated based on the second key to the next user side who has not shuffled to reshuffle the cards

S234: waiting for the encrypted card surface information to be broadcasted after reshuffling by the user side which finally shuffles in the current round of game;

if yes, executing the step S235: broadcasting all the encrypted card surface information generated based on the second key to the user sides participating in the current round of game;

S24: determining the plurality of pieces of encrypted card surface information allocated to the current users according to the preconfigured drawing rule;

S25: generating a plurality of pieces of third decryption request information according to the allocated encrypted card surface information and sending same to another user sides participating in the current round of game for decryption by the other user sides participating in the current round of game in turn by means of the key generated based on the algorithm, and then returning a plurality of third decryption results by the user side of the user sides decrypting finally;

S26: decrypting the third decryption results by means of the second key, and recognizing and filtering the scramble information to obtain the card surface information allocated to the current user; and

S27: receiving a plurality of pieces of fourth decryption request information sent by other user sides participating in the current round of game, and decrypting same by means of the second key so as to generate a fourth decrypted result, and sending same to the next user side.

Specifically, the method, as illustrated in FIG. 1, is executed by the user sides of a plurality of user sides of a round of game who start shuffling, while the method, as illustrated in FIG. 2, is executed by other user sides of the round of game. In the present embodiment, it, according to a pre-configured method, randomly assign a user side to start shuffling, wherein each of the user sides is respectively configured the programs for executing the methods illustrated in FIGS. 1 and 2. According to some other embodiments, under special game scenarios, it may, based on actual needs, assign a specific user side to start shuffling (the user side is configured the program for executing the method illustrated in FIG. 1) and assign other user sides to participate shuffling (other user sides are configured the program for executing the method illustrated in FIG. 2).

In the present embodiment, the user sides utilize RSA algorithm to generate their keys. Specifically, when a key is generated by means of RSA algorithm and includes a key pair (p,P), it utilizes P for encryption and utilizes p for out-of-order decryption. The user sides respectively keep secret of its own key in the entire dealing process and publish them after the current round of game ends. According to other embodiments, it may also utilize other keys that support out-of-order decryption and cannot be deduced based on the original text and the cipher text (such as A=m(a), in which the algorithm to generate the key cannot be deduced even with known original text a and known cipher text A. For another example, utilizing aes algorithm, generating a single key, and utilizing the key for encryption and out-of-order decryption can also achieve the same technical effect.

The following utilizes an example of user sides A, B, C, and D of the users A, B, C, and D who use two decks of cards (108 cards) per game for dealing in a Double Buckle game and each user side utilizes RSA algorithm for the explanations of the methods illustrated in the above FIGS. 1 and 2 in an exemplar manner.

After the current round of game has started, the user side A is determined, according to the pre-configured algorithm (for example, ordering based on the hash of the time stamp of the start of the current round of game and the addresses of the users or ordering based on the hash value of a random number provided by the blockchain and the addresses of the users, and etc.), to start shuffling:

The user side A executes the step S11 and the user sides B, C, and D execute the step S21. The user sides A, B, C, and D respectively generate key pairs (pA,PA) [symbol] (pB,PB) [symbol] (pC,PC) [symbol] (pD,PD) based on RSA algorithm and respectively generate hash values HA=(pA+PA), HB=(pB+PB), HC=(pC+PC), HD=(pD+PD) and respectively record HA, HB, HC, and HD onto the blockchain.

Preferably, in the steps S11 and S21, the user sides also respectively package the above hash value to the blockchain for the transaction of paying the deposit of the current round of game, wherein the game contract deployed on the blockchain freezes the deposits in the game contract when executing the transaction, so as for deducting the deposit for the compensations to the rest of the users when some user has eventually been detected cheating. According to some other embodiments, it may also, based on actual needs, require no deposit payment or require deposit payment before the start of the game.

After the step S11 has been executed, user side A executes the steps S12 and S13:

In the step S12, the user side A generates the 108 pieces of card surface information and corresponding scramble information based on the needed count of the cards (108). For example, the card surface information is deployed as i=1, 2 . . . , 54 for representing the 54 cards of the first deck of cards and i=55, . . . , 108 for representing the 54 cards of the second deck of cards (the actual corresponding relationships may be randomly deployed, pre-configured or temporarily deployed, as long as the other user sides have the pre-configuration, or received the same corresponding relationships table during the shuffling), wherein the scramble information corresponding to the card surface information are deployed as n(i)=hash(pA+i). Then the card surface information i and corresponding scramble information n(i) are encrypted through PA respectively so as to generate the encrypted card surface information of first time encryption EA(i)=PA(n(i)+i).

In the step S13, the user side A sends all the encrypted card surface information EA(1)-EA(108) generated in the step S12 to the user side D (for the example of the random deployed encryption shuffling order is ADCB, wherein it may also be randomly deployed as ACBD, ABDC, and etc.)

Here, the user side D also executes the steps S22 and S23 (S231-S235).

In the step S231, the user side D:respectively encrypts the received EA(1)-EA(108) according to PD, so as to generate ED(i)=PD(EA(i)). It should be noted here that though the user side A is capable of identifying the card surface information corresponding to EA(i), however the user side D is not capable of identifying the corresponding relationships between EA(i) and i, so after the user side D has finished encryption, all of the user sides A, B, C, and D are incapable of identifying the corresponding relationships between ED(i) and i.

In the step S232, user side D determines that user sides B and C have not shuffled yet based on the above random deployed encryption shuffling order ADCB and, therefore, executes the step S233 to send the ED(1)-ED((108) generated in the step S231 to user side C, and to execute the step S234 to wait for the encrypted card surface information to be broadcasted after reshuffling by the user side B.

Here, the user side C also executes the steps S22 and S23.

In the step S231, the user side C:encrypting the received ED(1)-ED(108) respectively according to PC;

In the step S232, user side C determines that user side B has not shuffled yet based on the above random deployed encryption shuffling order ADCB and, therefore, executes the step S233 to send the EC(1)-EC((108) generated in the step S231 to user side B, and to execute the step S234 to wait for the encrypted card surface information to be broadcasted after reshuffling by the user side B.

Here, the user side B also executes the steps S22 and S23.

In the step S231, the user side B:encrypting the received EC(1)-EC(108) respectively according to PB and generating EB(i)=PB(EC(i));

In the step S232, the user side B, based on the above random deployed encryption shuffling order, ADCB, determines that all user sides participating in the current round of game have finished shuffling and, therefore, executes the step S235 to broadcast all pieces of the encrypted card surface information EB(1)-EB(108) generated in the step S231 to the user sides A, C, and D.

After the user side B has broadcasted EB(1)-EB(108) to the user sides A, C, and D, the user side A will execute the step S14 and the user sides B, C, and D will execute the step S24:

All user sides determine the plurality of pieces of encrypted card surface information allocated to the current users (or other users) according to the preconfigured drawing rule Specifically, because none of the user sides is capable of knowing any of the 108 pieces of the encrypted card surface information corresponding to which of the cards, therefore it may be based on random algorithm (obviously, every user side should utilize the same algorithm) to randomly allocate 27 cards to each user without really allowing each user side to pick up one piece of encrypted card surface information in turn for the dealing process. For example, the user A is allocated the 27 pieces of encrypted card surface information, EB(3), EB(4), EB(7), . . . , and EB(106), the user B is allocated the 27 pieces of encrypted card surface information, EB(1), EB(5), . . . , and EB(108), the user C is allocated the 27 pieces of encrypted card surface information, EB(6), EB(9), . . . , and EB(104), and the user D is allocated the 27 pieces of encrypted card surface information, EB(2), EB(8), . . . , and EB(107).

After the allocation of the encrypted card surface information, the user side A decrypts the pieces of the encrypted card surface information that user A is allocated through executing the steps S15 and S16 as well as executes the step S17 to respectively coordinate with the user sides B, C, and D to decrypt the pieces of the encrypted card surface information that the users B, C, and D have been allocated. Similarly, the user sides B, C, and D decrypt the pieces of the encrypted card surface information allocated through executing the steps S25 and S26 as well as executes the step S27 to respectively coordinate with other user sides to decrypt the pieces of the encrypted card surface information that they have been allocated.

For the example of the user side A decrypts EB(3):

In the step S15, the user side A generates a decryption request information for requesting EB(3) and sends it to the user side D (for example, the decryption order of the decryption request of the user side A may be configured as DCB-A and the decryption order among the user sides B,C, and D may also be randomly configured);

The user side D executes the step S27 that after the decryption request information requesting for decrypting EB(3) sent from the user side A has been received, generating D D(3)=pD(EB(3)) through decrypting EB(3) with pD and sending both the decryption request information for decrypting EB(3) and D D(3) to the user side C;

The user side C also executes the step S27 that generating D C(3)=pC(D D(3)) through decrypting D D(3) with pC and sending both the decryption request information for decrypting EB(3) and D C(3) to the user side B;

The user side B also executes the step S27 that generating DB(3)=pB(D C(3)) through decrypting D C(3) with pB and sending DB(3) back to the user side A;

The user side A, after receiving DB(3), executes the step S16 that obtains hash(pA+3)+3 through decrypting DB(3) with pA and then obtains the card surface information 3 after filtering the scramble information hash(pA+3). During this process, only the user side A can learn the card surface information of the cards obtained by the user A through the step S16, and the user sides B, C, and D can only verify if the cards that the user side A discharged in the game were really obtained by the user A after the current round of game has ended and all the user sides have published their keys.

The decryptions for the user sides B, C, and D are similar to the above. The decryption request information is generated in the step S25 and then the rest three user sides successively execute the step S17 or S27 to utilize their own key to conduct decryption and then individually execute the step S26 to utilize its own key for decrypting and filtering the scramble information so as to obtain its own card surface information. These specific processes would not be repetitively mentioned here.

In the above embodiment, an example of 4 user sides conducting a round of Double Buckle game with 108 cards is utilized for illustration. However, person skilled in the art should be able to understand that, for more embodiments, the above method is capable of being suitable for any number of players to conduct any kind of games of non-revealing cards with any number of cards and achieving the same technical effects at the same time. Therefore, the method should not be limited by the above example.

The above embodiment achieves decentralized dealing allowing only each of the players know the cards s/he has in the game by means of having the user sides participating the game respectively generate keys based on an algorithm supporting out-of-order decryption, encryptedly record the keys onto the blockchain, respectively and successively utilize their keys to encryptedly shuffle the card surface information of the current round of game, successively decrypt the encrypted card surface information of each of the current user through other user sides after dealing, and eventually conduct the final decryption by each of the current user sides.

Further, preferably, in the methods provided by the above embodiments, the decryption request information includes the signature information of the corresponding users, wherein the signature information is utilized for verifying whether illegal decryption request sent by other user side has been received after the game is finished and the users respectively publish their keys.

For example, the decryption request information generated by user side A includes the signature of user A, the decryption request information generated by user side C includes the signature of user C, and etc. After the current round of game is finished, the user side A can verify if the encrypted card surface information that the decryption request information containing the signature of the user side B has requested to be decrypted is really corresponding and consist to the cards that the user B has obtained. If the decryption request information containing the signature of the user side B has requested to decrypt the cards that the user D has obtained to learn the cards of the user D to cheat, then the user side A can package the evidence of the cheat of the user side B into a transaction and submit it onto the blockchain. Once the game contract on the blockchain decides that the user side B has cheated, it can deduct the deposit of the user B and compensate the users A, C, and D (it may also not compensate, depending on the configuration based on actual needs.)

The above embodiment further prevents cheating in the decryption processes through providing the signature of the current user in the decryption request sending to other user sides, so as to ensure that illegal decryption request can be checked and found after all the users have published their keys.

FIG. 3 is a flow diagram of a game method according to an embodiment of the present invention. Referring to FIG. 3, according to the present embodiment, a game method also provided by the present invention comprises:

S31: dealing, according to any of the above dealing methods;

S32: sending dealing information in the game process to conducting dealing, wherein the dealing information comprises a first card surface information of the dealing, a first encrypted card surface information generated through successively shuffling the first card surface information by the user sides participating in the current round of game, and the signature information of the current users; and

S33: after the current round of game is finished, publishing the keys generated by the current user sides and packaging and recording the result information of the current round of game onto the blockchain, so as for the game contract deployed on the blockchain to settle the current round of game.

Specifically, in order to verify if there is user cheating, after the current round of game ends, every of the user sides has to publish his/her key, wherein s/he who fails to publish it in time may be considered as cheating based on the configuration, wherein the treatment to cheating would not be further stressed here.

Further, preferably, a third party (such as a centralized service side or a random user side who does not participate in the current round of game and etc.) may also be deployed in the game process to monitor if any of the user sides participating in the current round of game has been overtime (e.g. broken line and etc.) and to submit the monitoring result to the blockchain for settling.

The above embodiment further prevents cheating in the card leading processes through attaching the signature of the current user along with the encrypted card surface information in card leading, so as to ensure illegal card leading can be checked and found after all the users have published their keys.

FIG. 4 is a flow diagram of a preferred embodiment of the method of FIG. 3. Referring to FIG. 4, according to another preferred embodiment, the step S33 comprises:

S3311: packaging and recording the keys generated by the current user sides and the local first game result information onto the blockchain.

FIG. 5 is a flow diagram of another preferred embodiment of the method of FIG. 3. Referring to FIG. 5, according to another preferred embodiment, the step S33 comprises:

S3321: broadcasting the keys generated by the current user sides to other user sides participating in the current round of game and receiving the keys respectively broadcasted by other user sides participating in the current round of game;

S3322: settling the game locally based on the keys of the user sides participating in the current round of game and generating a second game result information; and

S3323: packaging and recording the keys generated by the current user sides and the second game result information onto the blockchain.

Specifically, differences between the game method illustrated in FIG. 4 and the game method illustrated in FIG. 5 are, for the game method illustrated in FIG. 4, in the step S33, the user sides package the keys and game data locally and then submit to the blockchain to be settled by the blockchain, while for the game method illustrated in FIG. 5, in the step S33, the user sides broadcast keys to one another, conduct local settling, and then respectively package the keys and settling result to the blockchain, wherein the blockchain only conducts checking computation when the settling results submitted by the user sides are different, so as to be capable of skipping settling computation when the settling results of the user sides are consistent.

Some of the above embodiments further enhance the system performance of decentralized games through performing local settling based on the local mutually broadcasted keys before submitting the game result to the blockchain, which reduces the computation load of the game contract on the blockchain.

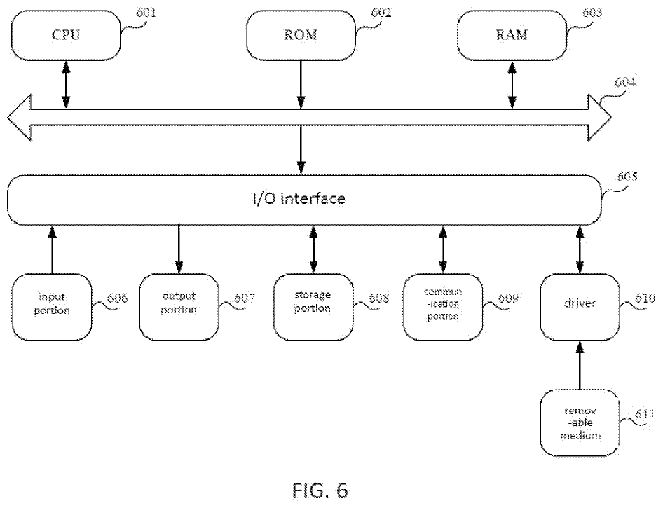

FIG. 6 is a composition diagram of a device according to an embodiment of the present invention.

Referring to FIG. 6, in another aspect, the present application also provides a device 600, which includes one or more central processing units (CPUs) 601 that can perform various suitable actions and processes in accordance with a program stored in a read-only memory (ROM) 602 or a program loaded into a random access memory (RAM) 603 from a storage portion 608. Various programs and data required for the operation of the device 600 are also stored in the RAM 603. The CPU 601, the ROM 602, and the RAM 603 are connected to each other via a bus 604. An input/output (I/O) interface 605 is also connected to the bus 604.

The following components are connected to the I/O interface 605: an input portion 606 including a keyboard, a mouse, and etc.; an output portion 607 including a cathode ray tube (CRT), a liquid crystal display (LCD), and etc., and a speaker and etc.; a storage portion 608 including a hard disk or the like; and a communication portion 609 including a network interface card, such as a LAN card, a modem, and etc. The communication portion 609 performs communication process via a network, such as the Internet. A driver 610 is also connected to the I/O interface 605 based on the needs. A removable media 611, such as magnetic disks, optical disks, magneto-optical disks, semiconductor memories, and etc., is mounted on the driver 610 based on the needs so that the computer programs read therefrom can be installed into the storage portion 608 as needed.

In particular, according to the embodiments of the present invention, the method described in any of the above embodiments may be implemented as the computer program. For example, an embodiment of the present invention may provide a computer program product, which includes a computer program tangibly loaded on a machine-readable medium containing program code for performing the above method. According to such embodiment, the computer program may be downloaded and installed from the network through the communication portion 609 and/or installed from the removable medium 611.

As yet another aspect, the present application also provides a computer-readable storage medium, which may be a computer-readable storage medium included in a device of the above-described embodiments, or a computer-readable storage medium that may be provided separately, without being assembled in the device. The computer-readable storage medium stores one or more programs that are utilized by one or more processors to perform a method disclosed in the present application.

The flow chart and block diagrams in the figures illustrate the constructions, functionality, and operation of possible implementations of the systems, methods, and computer program products according to various embodiments of the present invention. In this regard, each block in the flow chart or block diagrams may represent a module, segment, or portion of code, which includes one or more executable instructions for implementing the specified logical function (s). It should also be noted that, in some alternative implementations, the functions illustrated in the block may occur out of the order illustrated in the figures. For example, two blocks represented in succession may, in fact, be executed substantially concurrently, or the blocks may sometimes be executed in the reverse order, depending upon the functionality involved. It will also be noted that each block of the block diagrams and/or flow chart illustration, and combinations of the blocks in the block diagrams and/or flow chart illustration, may be implemented by special purpose hardware-based systems that perform the specified functions or acts, or combinations of special purpose hardware and computer instructions.

The units or modules described in the embodiments of the present application may be implemented in a software manner, or may be implemented in a hardware manner. The described units or modules may also be provided in a processor, for example, each of which may be a software program disposed in a computer or a mobile smart device or a separately configured hardware device. The names of these units or modules, in some cases, do not constitute a definition of the unit or module itself.

The above description is merely preferred embodiment(s) of the present application and is intended to be illustrative of the principles of the application. It should be understood by those skilled in the art that the scope of the present invention referred to herein is not limited to the particular combination of the above-described technical features, but also to other technical solutions formed by any combination of the above-described technical features or the equivalent features thereof without departing from the concepts of the present application. For example, technical solutions that are formed through alternating or interchanging the features described above and the technical features disclosed in this application (but are not limited to) with similar feature(s).

1-9. (canceled)

10: A dealing method, comprising:
generating a first key by means of an algorithm supporting out-of-order decryption, and recording a hash value of the first key onto a blockchain, wherein all other user sides participating in the current round of game respectively generate key through the algorithm and record a hash value of the first key onto the blockchain;
generating a plurality of pieces of card surface information and corresponding scramble information, and respectively encrypting the card surface information and the corresponding scramble information by means of the first key so as to generate a plurality of pieces of encrypted card surface information that are encrypted for the first time;
sending the encrypted card surface information to another user side participating in the current round of game for reshuffling cards in turn by other user sides participating in the current round of game, until all user sides participating in the current round of game finish shuffling, wherein the shuffling comprises: encrypting the encrypted card surface information received respectively by means of the key generated according to the algorithm;
receiving the encrypted card surface information broadcasted after reshuffling by the user side which finally shuffles in the current round of game, and determining, according to a preconfigured drawing rule, the plurality of pieces of encrypted card surface information allocated to the current user;
generating a plurality of pieces of first decryption request information according to the allocated encrypted card surface information and sending same to another user sides participating in the current round of game for decryption by the other user sides participating in the current round of game in turn by means of the key generated based on the algorithm, and then returning a plurality of first decryption results by the user side of the user sides decrypting finally;
decrypting the first decryption results by means of the first key, and recognizing and filtering the scramble information to obtain the card surface information allocated to the current user; and
receiving a plurality of pieces of second decryption request information sent by other user sides participating in the current round of game, and decrypting same by means of the first key so as to generate a second decrypted result, and sending same to the next user side.

11: The method, as recited in claim 10, wherein the first decryption request information and the second decryption request information respectively include signature information of the corresponding users, wherein the signature information is utilized for verifying whether illegal decryption request sent by other user side is received after the game is finished and the users respectively publish their keys generated by means of the algorithm.

12: A dealing method, comprising:
generating a second key by means of an algorithm supporting out-of-order decryption, and recording a hash value of the second key onto a blockchain, wherein all other user sides participating in the current round of game respectively generate key through the algorithm and record a hash value of the first key onto the blockchain;
receiving a plurality of pieces of encrypted card surface information transmitted by another user side participating in the current round of game, wherein the encrypted card surface information is an encrypted card surface information of first time encryption or an encrypted card surface information of second time encryption, wherein the encrypted card surface information of first time encryption is generated by a first user side starting the shuffling of the current round of game through generating a plurality of pieces of card surface information and corresponding scramble information and respectively encrypting the card surface information and the corresponding scramble information with a first key generated based on the algorithm and is sent to another user side participating in the current round of game, so as for the other user sides participating in the current round of game to successively reshuffling the cards, wherein the reshuffling comprising: encrypting all pieces of the encrypted card surface information received respectively with a key generated based on the algorithm so as to generate an encrypted card surface information of second time encryption;
encrypting the received encrypted card surface information based on the second key and determining whether all user sides participating in the current round of game have finished shuffling:
if no, sending all the encrypted card surface information generated based on the second key to the next user side who has not shuffled to reshuffle the cards, and waiting for the encrypted card surface information to be broadcasted after reshuffling by the user side which finally shuffles in the current round of game;
if yes, broadcasting all the encrypted card surface information generated based on the second key to the user sides participating in the current round of game;
determining the plurality of pieces of encrypted card surface information allocated to the current users according to the preconfigured drawing rule;
generating a plurality of pieces of third decryption request information according to the allocated encrypted card surface information and sending same to another user sides participating in the current round of game for decryption by the other user sides participating in the current round of game in turn by means of the key generated based on the algorithm, and then returning a plurality of third decryption results by the user side of the user sides decrypting finally;
decrypting the third decryption results by means of the second key, and recognizing and filtering the scramble information to obtain the card surface information allocated to the current user; and
receiving a plurality of pieces of fourth decryption request information sent by other user sides participating in the current round of game, and decrypting same by means of the second key so as to generate a fourth decrypted result, and sending same to the next user side.

13: The method, as recited in claim 12, wherein the third decryption request information and the fourth decryption request information respectively include signature information of the corresponding users, wherein the signature information is utilized for verifying whether illegal decryption request sent by other user side is received after the game is finished and the users respectively publish their keys generated by means of the algorithm.

14: A game method, comprising:
dealing, based on the dealing method, as recited in claim 10, after the game begins;
sending dealing information in the game process to conducting dealing, wherein the dealing information comprises a first card surface information of the dealing, a first encrypted card surface information generated through successively shuffling the first card surface information by the user sides participating in the current round of game, and the signature information of the current users; and
after the current round of game is finished, publishing the keys generated by the current user sides and packaging and recording the result information of the current round of game onto the blockchain, so as for the game contract deployed on the blockchain to settle the current round of game.

15: The method, as recited in claim 14, wherein after the current round of game is finished, publishing the keys generated by the current user sides and packaging and recording the result information of the current round of game onto the blockchain, comprising:
packaging and recording the keys generated by the current user sides and the local first game result information onto the blockchain.

16: The method, as recited in claim 14, wherein after the current round of game is finished, publishing the keys generated by the current user sides and packaging and recording the result information of the current round of game onto the blockchain, comprising:
broadcasting the keys generated by the current user sides to other user sides participating in the current round of game and receiving the keys respectively broadcasted by other user sides participating in the current round of game;
settling the game locally based on the keys of the user sides participating in the current round of game and generating a second game result information; and
packaging and recording the keys generated by the current user sides and the second game result information onto the blockchain.

17: A device for gaming, comprising:
one or more processors; and
a storage medium, configured for storing one or more programs, wherein when the one or more processors are allowed to execute one of a dealing method and a game method.

18: The device, as recited in claim 17, wherein the dealing method comprising:
generating a first key by means of an algorithm supporting out-of-order decryption, and recording a hash value of the first key onto a blockchain, wherein all other user sides participating in the current round of game respectively generate key through the algorithm and record a hash value of the first key onto the blockchain;
generating a plurality of pieces of card surface information and corresponding scramble information, and respectively encrypting the card surface information and the corresponding scramble information by means of the first key so as to generate a plurality of pieces of encrypted card surface information that are encrypted for the first time;
sending the encrypted card surface information to another user side participating in the current round of game for reshuffling cards in turn by other user sides participating in the current round of game, until all user sides participating in the current round of game finish shuffling, wherein the shuffling comprises: encrypting the encrypted card surface information received respectively by means of the key generated according to the algorithm;
receiving the encrypted card surface information broadcasted after reshuffling by the user side which finally shuffles in the current round of game, and determining, according to a preconfigured drawing rule, the plurality of pieces of encrypted card surface information allocated to the current user;
generating a plurality of pieces of first decryption request information according to the allocated encrypted card surface information and sending same to another user sides participating in the current round of game for decryption by the other user sides participating in the current round of game in turn by means of the key generated based on the algorithm, and then returning a plurality of first decryption results by the user side of the user sides decrypting finally;
decrypting the first decryption results by means of the first key, and recognizing and filtering the scramble information to obtain the card surface information allocated to the current user; and
receiving a plurality of pieces of second decryption request information sent by other user sides participating in the current round of game, and decrypting same by means of the first key so as to generate a second decrypted result, and sending same to the next user side.

19: The device, as recited in claim 18, wherein the first decryption request information and the second decryption request information respectively include signature information of the corresponding users, wherein the signature information is utilized for verifying whether illegal decryption request sent by other user side is received after the game is finished and the users respectively publish their keys generated by means of the algorithm.

20: The device, as recited in claim 17, wherein the dealing method comprising:
generating a second key by means of an algorithm supporting out-of-order decryption, and recording a hash value of the second key onto a blockchain, wherein all other user sides participating in the current round of game respectively generate key through the algorithm and record a hash value of the first key onto the blockchain;
receiving a plurality of pieces of encrypted card surface information transmitted by another user side participating in the current round of game, wherein the encrypted card surface information is an encrypted card surface information of first time encryption or an encrypted card surface information of second time encryption, wherein the encrypted card surface information of first time encryption is generated by a first user side starting the shuffling of the current round of game through generating a plurality of pieces of card surface information and corresponding scramble information and respectively encrypting the card surface information and the corresponding scramble information with a first key generated based on the algorithm and is sent to another user side participating in the current round of game, so as for the other user sides participating in the current round of game to successively reshuffling the cards, wherein the reshuffling comprising: encrypting all pieces of the encrypted card surface information received respectively with a key generated based on the algorithm so as to generate an encrypted card surface information of second time encryption;
encrypting the received encrypted card surface information based on the second key and determining whether all user sides participating in the current round of game have finished shuffling:
if no, sending all the encrypted card surface information generated based on the second key to the next user side who has not shuffled to reshuffle the cards, and waiting for the encrypted card surface information to be broadcasted after reshuffling by the user side which finally shuffles in the current round of game;
if yes, broadcasting all the encrypted card surface information generated based on the second key to the user sides participating in the current round of game;
determining the plurality of pieces of encrypted card surface information allocated to the current users according to the preconfigured drawing rule;
generating a plurality of pieces of third decryption request information according to the allocated encrypted card surface information and sending same to another user sides participating in the current round of game for decryption by the other user sides participating in the current round of game in turn by means of the key generated based on the algorithm, and then returning a plurality of third decryption results by the user side of the user sides decrypting finally;
decrypting the third decryption results by means of the second key, and recognizing and filtering the scramble information to obtain the card surface information allocated to the current user; and
receiving a plurality of pieces of fourth decryption request information sent by other user sides participating in the current round of game, and decrypting same by means of the second key so as to generate a fourth decrypted result, and sending same to the next user side.

21: The device, as recited in claim 20, wherein the third decryption request information and the fourth decryption request information respectively include signature information of the corresponding users, wherein the signature information is utilized for verifying whether illegal decryption request sent by other user side is received after the game is finished and the users respectively publish their keys generated by means of the algorithm.

22: The device, as recited in claim 17, wherein the game method comprising:
dealing, based on the dealing method, as recited in claim 10, after the game begins;
sending dealing information in the game process to conducting dealing, wherein the dealing information comprises a first card surface information of the dealing, a first encrypted card surface information generated through successively shuffling the first card surface information by the user sides participating in the current round of game, and the signature information of the current users; and
after the current round of game is finished, publishing the keys generated by the current user sides and packaging and recording the result information of the current round of game onto the blockchain, so as for the game contract deployed on the blockchain to settle the current round of game.

23: The device, as recited in claim 22, wherein after the current round of game is finished, publishing the keys generated by the current user sides and packaging and recording the result information of the current round of game onto the blockchain, comprising:
packaging and recording the keys generated by the current user sides and the local first game result information onto the blockchain.

24: The device, as recited in claim 22, wherein after the current round of game is finished, publishing the keys generated by the current user sides and packaging and recording the result information of the current round of game onto the blockchain, comprising:
broadcasting the keys generated by the current user sides to other user sides participating in the current round of game and receiving the keys respectively broadcasted by other user sides participating in the current round of game;
settling the game locally based on the keys of the user sides participating in the current round of game and generating a second game result information; and
packaging and recording the keys generated by the current user sides and the second game result information onto the blockchain.
